(19) United States
(12) Patent Application Publication
(10) Pub. No.: US 2013/0095419 A1
(43) Pub. Date: Apr. 18, 2013

(54) DEVELOPER AND IMAGE FORMING APPARATUS

(71) Applicant: Koichi Kuroyama, Kanagawa (JP)

(72) Inventor: Koichi Kuroyama, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/628,710

(22) Filed: Sep. 27, 2012

Related U.S. Application Data
(60) Provisional application No. 61/546,122, filed on Oct. 12, 2011.

(51) Int. Cl. G03G 9/00; G03G 15/08

(52) U.S. Cl. 430/105; 399/252; 430/108.1; 430/108.3; 977/773

(57) ABSTRACT

A developer according to an embodiment includes toner particles, wherein the toner particles contain an amorphous polyester resin, a crystalline polyester resin, a coloring material, and a charge control agent containing metal elements of aluminum and magnesium, and have an endothermic peak temperature as measured by a differential scanning calorimeter (DSC) of from 90 to 100° C. and an acid value of from 9 to 19 mgKOH/g.

### CROSS-REFERENCE TO RELATED APPLICATION

This application is based upon and claims the benefit of priority from provisional U.S. Patent Application 61/546122 filed on Oct. 12, 2011, the entire contents of which are incorporated herein by reference.

### TECHNICAL FIELD

Embodiments described herein relate to a developer which has excellent low-temperature fixability and excellent charging stability.

### BACKGROUND

In recent years, due to the trend of energy saving in consideration of environment, a toner to be used in an image forming apparatus is required to be able to be fixed at a lower temperature than a conventional fixing temperature, i.e., to have low-temperature fixability. In order to achieve such a toner, many studies were conducted for toners in which, for example, crystalline polyester is incorporated in amorphous polyester as a binder resin. However, such a toner has problems such that the chargeability of a developer is low, toner scattering becomes worse than conventional toners, and the prolongation of life is not easy.

### BRIEF DESCRIPTION OF THE DRAWINGS

The accompanying drawing, which is incorporated in and constitute a part of this specification, illustrates an embodiment of the invention and together with the description, serve to explain the principles of the invention.

FIG. 1 is an exemplary view showing an image forming apparatus according to an embodiment.

### DETAILED DESCRIPTION

Reference will now be made in detail to the present embodiment of the invention, an example of which is illustrated in the accompanying drawing.

According to the present embodiment, provided is a developer including toner particles, wherein the toner particles contain an amorphous polyester resin, a crystalline polyester resin, a coloring material, and a charge control agent containing metal elements of aluminum (Al) and magnesium (Mg), and have an endothermic peak temperature as measured by a differential scanning calorimeter (DSC) of from 90 to 100° C. and an acid value of from 9 to 19 mgKOH/g.

Further, according to the present embodiment, provided is an image forming apparatus including an image carrier on which an electrostatic latent image is formed, a toner for use in developing an electrostatic latent image on the image carrier, and a developing device in which a developer containing the toner is accommodated, wherein the toner contains an amorphous polyester resin, a crystalline polyester resin, a coloring material, and a charge control agent containing metal elements of aluminum and magnesium, and has an endothermic peak temperature as measured by a differential scanning calorimeter (DSC) of from 90 to 100° C. and an acid value of from 9 to 19 mgKOH/g.

A crystalline polyester resin which is favorably blended from the viewpoint of realization of low-temperature fixability has a low melt viscosity, and therefore deteriorates the dispersibility of the respective materials to be blended in a kneading step when producing a pulverized toner, decreases the chargeability of the toner, and causes much toner scattering. Further, since the glass transition point (Tg) of the toner is decreased, the storage stability of the toner is deteriorated, and moreover, a problem arises that the chargeability is more easily deteriorated by carrier contamination of the toner as the temperature in a developing device is raised.

In the present embodiment, it is possible to provide a toner wherein such a problem caused by the crystalline polyester resin is improved, a decrease in chargeability is suppressed while maintaining excellent low-temperature fixability, the prolongation of life of a developer is achieved, and also storage stability can be improved. Specifically, with respect to the deterioration of the dispersibility of the respective materials to be blended, by increasing the acid value of the toner, the charging amount is increased, and also by blending a charge control agent simultaneously containing Al and Mg, the chargeability can be further improved. In addition, by setting the endothermic peak temperature of the toner as measured by a differential scanning calorimeter (DSC) to 90 to 100° C., the low-temperature fixability can be maintained. Further, by adding an external additive having a particle diameter larger than that generally used to the surfaces of the toner particles, the storage stability can be improved by a spacing effect between toner particles and between the toner and the carrier, and also carrier contamination and the like can be prevented and the deterioration of the chargeability can be prevented.

In this manner, according to the present embodiment, a toner which has excellent low-temperature fixability and storage stability and can satisfy the quality property of prolongation of life can be provided.

Hereinafter, embodiments will be described in detail.

The amorphous polyester resin to be used in the present embodiment is blended as a binder resin. As a raw material monomer of the amorphous polyester resin, for example, a dihydric or higher hydric alcohol component and a divalent or higher valent carboxylic acid component such as a carboxylic acid, a carboxylic acid anhydride, or a carboxylic acid ester are used.

Specific examples of the dihydric alcohol component include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0) -2,2-bis(4-hydroxyphenyl)propane, polyoxypropylene(2.0)-polyoxyethylene(2.0)-2,2-bis(4-h ydroxyphenyl)propane, and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, and hydrogenated bisphenol A.

Among these, a bisphenol A alkylene (carbon number: 2 or 3) oxide adduct (average addition molar number: 1 to 10), ethylene glycol, propylene glycol, 1,6-hexanediol, bisphenol A, hydrogenated bisphenol A, or the like is preferred.

Examples of the trihydric or higher hydric alcohol component include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Among these, sorbitol, 1,4-sorbitan, pentaerythritol, glycerol, trimethylolpropane, or the like is preferred.

Among these alcohol components, one alcohol component can be used alone or a plurality of alcohol components can be used in combination. In particular, it is preferred to use, as a main component, a bisphenol A alkylene (carbon number: 2 or 3) oxide adduct (average addition molar number: 1 to 10).

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenyl succinic acids such as n-dodecenyl succinic acid, alkyl succinic acids such as n-dodecyl succinic acid, and acid anhydrides or lower alkyl esters thereof.

Among these, maleic acid, fumaric acid, terephthalic acid, succinic acid substituted by an alkenyl group having 2 to 20 carbon atoms, or the like is preferred.

Examples of the trivalent or higher valent carboxylic acid component include 1,2,4-benzenetricarboxylic acid (trimellitic acid) 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra (methylenecarboxyl) methane, 1,2,7,8-octanetetracarboxylic acid, pyromellitic acid, enpol trimer acid, and acid anhydrides or lower alkyl esters thereof.

Among these, 1,2,4-benzenetricarboxylic acid (trimellitic acid), or an acid anhydride or lower alkyl (carbon number: 1 to 12) ester thereof, or the like is preferred.

Among these carboxylic acid components, one carboxylic acid component can be used alone or a plurality of carboxylic acid components can be used in combination. In particular, it is preferred to use, as a main component, fumaric acid, terephthalic acid, or succinic acid substituted by an alkenyl group having 2 to 20 carbon atoms, each of which is a divalent carboxylic acid component, 1,2,4-benzenetricarboxylic acid (trimellitic acid), which is a trivalent or higher valent carboxylic acid component, or an acid anhydride or alkyl (carbon number: 1 to 12) ester thereof, or the like.

The glass transition point (Tg) of the amorphous polyester resin to be used in the present embodiment is preferably from 55 to 60° C. If the Tg thereof is lower than 55° C., although the low-temperature fixability is favorable, the storage stability is deteriorated. On the other hand, if the Tg thereof is higher than 60° C., the low-temperature fixability is deteriorated. In addition, the melting point (Tm) of the amorphous polyester resin to be used in the present embodiment is preferably from 110 to 120° C. If the Tm thereof is lower than 110° C., fixing failure (high-temperature offset) is liable to occur when the temperature of a fixing device is increased. On the other hand, if the Tm thereof is higher than 120° C., the surface smoothness (evenness) of an image is deteriorated, and therefore, glossiness is decreased.

Further, the acid value of the amorphous polyester resin is preferably from 7 to 17 mgKOH/g. Since the amorphous polyester resin of the present embodiment accounts for the majority of the percentage of the constituent materials of the toner, if the acid value of the amorphous polyester resin exceeds the above range, it becomes not easy to adjust to the acid value of the toner of the present embodiment.

Examples of an acid component as a raw material monomer of the crystalline polyester resin to be used in the present embodiment include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecyl succinic acid, n-dodecenyl succinic acid, cyclohexanedicarboxylic acid, trimellitic acid, pyromellitic acid, and acid anhydrides or alkyl (carbon number: 1 to 3) esters thereof. Among these, fumaric acid is preferred.

Examples of an alcohol component as a raw material monomer of the crystalline polyester resin to be used in the present embodiment include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. Among these, 1,4-butanediol or 1,6-hexanediol is preferred.

The addition amount of the crystalline polyester resin in the toner particles is preferably from 3 to 15% by weight. If the addition amount thereof is less than 3% by weight, the fixation at a low temperature becomes insufficient. On the other hand, if the addition amount thereof exceeds 15% by weight, the prolongation of life and the storage stability in a high temperature environment cannot be satisfied.

Incidentally, in the present embodiment, a polyester resin having a ratio of the softening point to the melting temperature (softening point/melting temperature) of from 0.9 to 1.1 is referred to as the crystalline polyester resin.

In polymerizing the raw material monomers of the polyester, in order to promote the reaction, a catalyst which is usually used, such as dibutyltin oxide, a titanium compound, a dialkoxytin(II), tin(II) oxide, a fatty acid tin(II), tin(II) dioctanoate, or tin(II) distearate may be properly used.

In the present embodiment, as the charge control agent, a charge control agent containing aluminum (Al) and magnesium (Mg) is preferably contained. By incorporating Al and Mg, it becomes possible to maintain high chargeability and to suppress a decrease in charging amount as time progresses. As the charge control agent containing Al and Mg as metal elements, a compound, a complex, and a complex salt, each containing these metals, and a mixture thereof can be exemplified. Specific examples thereof include charge control agents such as a metal-containing azo compound, a metal-containing salicylic acid derivative compound, a clathrate compound of a polysaccharide, and a hydrophobized metal oxide, each containing Al and Mg. Among these, particularly, a clathrate compound of a polysaccharide containing Al and Mg is preferred. In addition, the charge control agent containing Al and Mg may further contain any one of Fe, Cr, and Zr, or two or more thereof as metal elements. Further, one or more other types of charge control agents may be used in combination.

The addition amount of the charge control agent containing Al and Mg is preferably from 0.5 to 3 parts by weight with respect to 100 parts by weight of the binder resin. If the addition amount thereof is less than 0.5 parts by weight, the effect of improving the chargeability is low and desired chargeability cannot be obtained. On the other hand, if the addition amount thereof exceeds 3 parts by weight, the chargeability in a high temperature and high humidity environment tends to be deteriorated instead of improving. Further, if the addition amount thereof is large, the dispersion of the charge control agent in the toner tends to be deteriorated, and fixing device members are liable to be dirty, etc. The addition amount thereof is preferably from 0.75 to 2.0 parts by weight.

As the coloring material of the present embodiment, a carbon black, an organic or inorganic pigment or dye, or the like, which is used in a color toner, can be used. The type of the coloring material is not particularly limited, and examples of the carbon black include acetylene black, furnace black, thermal black, channel black, and ketjen black. Examples of the pigment or dye include Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green, and quinacridone. These coloring materials can be used alone or in admixture. Also, the addition amount of the coloring material is not particularly limited, and for example, the addition amount thereof can be set to 4 to 10 parts by weight with respect to 100 parts by weight of the binder resin.

The toner of the present embodiment preferably has an endothermic peak temperature as measured by a differential scanning calorimeter (DSC) of from 90 to 100° C. If the endothermic peak temperature thereof is lower than 90° C., the storage stability tends to be deteriorated. On the other hand, if the endothermic peak temperature thereof is higher than 100° C., fixing failure tends to be caused. Further, the toner preferably has an acid value of from 9 to 19 mgKOH/g. If the acid value of the toner is lower than 9 mgKOH/g, the charging amount is low and image failure or the like is liable to occur in a high temperature and high humidity environment. On the other hand, if the acid value of the toner is higher than 19 mgKOH/g, a difference in charging amount between in a low temperature and low humidity environment and in a high temperature and high humidity environment is liable to be increased, and the environmental stability of the charging amount is deteriorated.

The Tg of the toner is preferably from 34 to 44° C. If the Tg of the toner is lower than 34° C., although the low-temperature fixability is favorable, the storage stability is deteriorated. On the other hand, if the Tg of the toner is 45° C. or higher, the low temperature fixability is deteriorated. Further, the melting point (Tm) of the toner is preferably from 95 to 105° C. If the Tm of the toner is lower than 95° C., fixing failure (high temperature offset) is liable to occur when the temperature of a fixing device is increased. On the other hand, if the Tm of the toner is higher than 105° C., the surface smoothness (evenness) of an image is deteriorated, and therefore, glossiness is decreased.

In the present embodiment, in addition to the above-described materials, a release agent can be added to the toner. The release agent is not particularly limited, and for example, a natural wax such as carnauba wax or rice wax or a synthetic wax such as propylene or polyethylene can be used.

These materials are mixed and dispersed, whereby toner particles are produced. As a mixing machine, for example, Henschel Mixer (manufactured by Mitsui Mining Co., Ltd.); Super Mixer (manufactured by Kawata MFG Co., Ltd.); Ribocorn (manufactured by Okawara Corporation); Nauta Mixer, Turbulizer, and Cyclomix (all of which are manufactured by Hosokawa Micron Corporation); Spiralpin Mixer (manufactured by Pacific Machinery & Engineering Co., Ltd.); and Lodige Mixer (manufactured by Matsubo Corporation) can be exemplified. As a kneading machine, a KRC kneader (manufactured by Kurimoto, Ltd.); Buss Ko-Kneader (manufactured by Buss AG); a TEM type extruder (manufactured by Toshiba Machine Co., Ltd.); a TEX twin-screw kneading machine (manufactured by The Japan Steel Works, Ltd.); a PCM kneading machine (manufactured by Ikegai, Ltd.); a three-roll mill, a mixing roll mill, and a kneader (all of which are manufactured by Inoue Mfg., Inc.); Kneadex (manufactured by Mitsui Mining Co., Ltd.); an MS type pressure kneader and a kneader-ruder (both of which are manufactured by Moriyama Company Ltd.); Banbury mixer (manufactured by Kobe Steel, Ltd.), etc. can be exemplified.

As a device for coarsely pulverizing the mixture, for example, a hammer mill, a cutter mill, a jet mill, a roller mill, a ball mill, etc. can be exemplified. Also, as a device for finely pulverizing the coarsely pulverized material, a counter jet mill, Micron jet, and Inomizer (all of which are manufactured by Hosokawa Micron Corporation) an IDS type mill and a PJM jet pulverizer (both of which are manufactured by Nippon Pneumatic Mfg. Co., Ltd.); Cross jet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); Turbo Mill (manufactured by Turbo Kogyo Co., Ltd.), etc. can be exemplified.

Also, as a classifying machine for classifying the finely pulverized material, for example, Classiel, Micron Classifier, and Spedic Classifier (all of which are manufactured by Seisin Enterprises Co., Ltd.); Turbo Classifier (manufactured by Nisshin Engineering Co., Ltd.); Micron Separator, Turboplex ATP, and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.) can be exemplified.

In the present embodiment, in order to stabilize the fluidity, chargeability, and storage stability of the toner, it is preferred to add fine particles of an external additive to the surfaces of the toner particles. As the fine particles of an external additive, for example, fine particles of an inorganic oxide such as silica, titania, alumina, strontium titanate, or tin oxide can be exemplified. As such fine particles of an inorganic oxide, it is preferred to use those surface-treated with a hydrophobizing agent from the viewpoint of improvement of environmental stability.

The average primary particle diameter of the fine particles of an external additive is preferably from 70 to 150 nm. By adding the fine particles of an inorganic oxide having such a particle diameter, it becomes possible to improve the storage stability and deterioration of the chargeability due to carrier contamination by a spacing effect between toner particles and between the toner and the carrier, and storage stability and the prolongation of life (no toner scattering) can be satisfied. Further, as the fine particles of an external additive, fine particles of two or more types of inorganic oxides having different average primary particle diameters can be used in admixture. Further, as the fine particles of an external additive, resin fine particles having an average primary particle diameter of 1 μm or less can also be added other than such fine particles of an inorganic oxide. As a device for adding the fine particles of an external additive, the above-described mixing machine is used.

As a sieving deice to be used for sieving out coarse particles and the like, Ultra Sonic (manufactured by Koei Sangyo Co., Ltd.); Resona Sieve and Gyro sifter (both of which are manufactured by Tokuju Corporation); Vibrasonic System (manufactured by Dalton Co., Ltd.); Soniclean (manufactured by Shinto Kogyo Kabushiki Kaisha); Turbo screener (manufactured by Turbo Kogyo Co., Ltd.); Micro sifter (manufactured by Makino Mfg. Co., Ltd.); a circular vibrating sieve; etc. can be exemplified.

Such a developer is used in, for example, an image forming apparatus as described below.

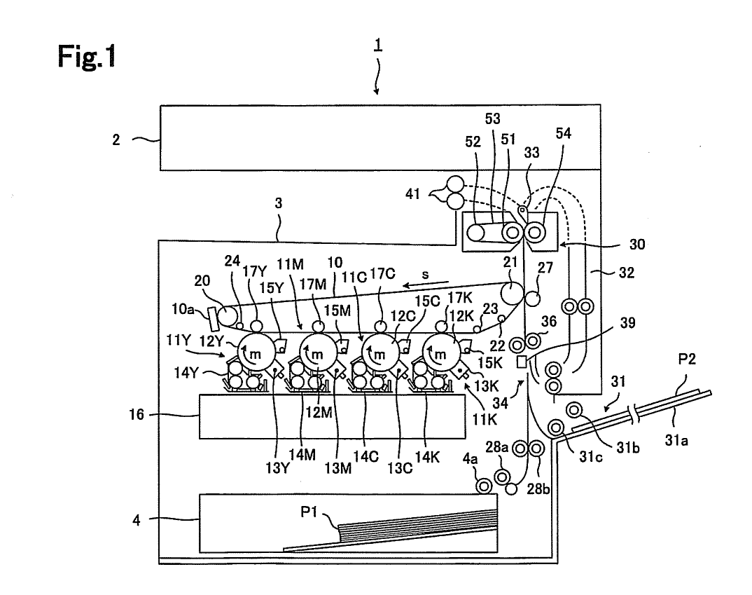

A diagrammatic view showing an example of an image forming apparatus to which the developing agent according to the embodiment is applicable is shown in FIG. 1. As shown in FIG. 1, a scanner section 2 and a paper discharge section 3 are provided in an upper portion of a color copier, MFP 1 of a quadruple tandem system.

The color copier 1 has image forming stations 11Y, 11M, 11C and 11K of four groups of yellow (Y), magenta (M), cyan (C) and black (K) disposed in parallel along a lower side of an intermediate transfer belt (intermediate transfer medium) 10.

The respective image forming stations 11Y, 11M, 11C and 11K have photoreceptor drums (image carriers) 12Y, 12M, 12C and 12K, respectively. In the surroundings of the photoreceptor drums 12Y, 12M, 12C and 12K, electrification chargers 13Y, 13M, 13C and 13K; development apparatuses 14Y, 14M, 14C and 14K; and photoreceptor cleaning apparatuses 15Y, 15M, 15C and 15K are disposed along the rotation direction shown by an arrow m direction.

On the way from the electrification chargers 13Y, 13M, 13C and 13K to the development apparatuses 14Y, 14M, 14C and 14K in the surroundings of the photoreceptor drums 12Y, 12M, 12C and 12K, laser light is applied by a laser exposure apparatus (latent image forming apparatus) 16, an electrostatic latent image is formed on the photoreceptor drums 12Y, 12M, 12C and 12K.

Each of the development apparatuses 14Y, 14M, 14C and 14K has a two-component developing agent composed of each of yellow (Y), magenta (M), cyan (C) and black (K) toners and a carrier, respectively and feeds the toner to the electrostatic latent image on the photoreceptor drums 12Y, 12M, 12C and 12K, respectively.

The intermediate transfer belt 10 is hung by a backup roller 21, a driven roller 20 and first to third tension rollers 22 to 24. The intermediate transfer belt 10 is opposed to and brought into contact with the photoreceptor drums 12Y, 12M, 12C and 12K. Primary transfer rollers 17Y, 17M, 17C and 17K for primarily transferring the toner images on the photoreceptor drums 12Y, 12M, 12C and 12K onto the intermediate transfer belt 10 are provided at positions of the intermediate transfer belt 10 opposing the photoreceptor drums 12Y, 12M, 12C and 12K, respectively. Each of these primary transfer rollers 17Y, 17M, 17C and 17K is a conductive roller, and a primary transfer bias voltage is impressed in each of these primary transfer sections.

A secondary roller 27 is disposed in a secondary transfer section which is a transfer position of the intermediate transfer belt 10 supported by the backup roller 21. In the secondary transfer section, the backup roller 21 is a conductive roller, and a prescribed secondary transfer bias is impressed thereto. When a sheet paper (a final transfer medium) which is an object to printing passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned up by a belt cleaner 10a.

A paper feed cassette 4 for feeding a sheet paper P1 toward the direction of the secondary transfer roller 27 is provided in a lower portion of the laser exposure apparatus 16. A manual-bypass mechanism 31 for manually feeding a sheet paper P2 is provided on the right side of the color copier 1. On the way from the paper feed cassette 4 to the secondary transfer roller 27, a pickup roller 4a, a separation roller 28a, a carrying roller 28b and a resist roller pair 36 are provided, thereby constituting a paper feed mechanism.

On the way from a manual-bypass tray 31a of the manual-bypass mechanism 31 to the resist roller pair 36, a manual-bypass pickup roller 31b and a manual-bypass separation roller 31c are provided. Furthermore, a medium sensor 39 for detecting the kind of sheet paper is disposed on a vertical carrying route 34 for carrying the sheet paper from the paper feed cassette 4 or the manual-bypass tray 31a toward the direction of the secondary transfer roller 27. The color copier 1 is able to control a carrying rate of sheet paper, a transfer condition, a fixing condition and so on from the detection results by the medium sensor 39. Also, a fuser units 30 is provided in the downstream of the secondary transfer section along the direction of the vertical carrying route 34. The sheet paper taken out from the paper feed cassette 4 or fed from the manual-bypass mechanism 31 is carried into the fuser units 30 through the resist roller pair 36 and the secondary transfer roller 27 along the vertical carrying route 34.

The fuser units 30 has a fuser units 53 wound around a pair of a heating roller 51 and a driving roller 52 and a counter roller 54 disposed opposing the heating roller 51 via the fuser units 53. The sheet paper having a toner image transferred in the secondary transfer section is introduced between the fuser units 53 and the counter roller 54, and the toner image transferred onto the sheet paper is heat treated and fixed upon heating by the heating roller 51. A gate 33 is provided in the downstream of the fuser units 30, whereby the sheet paper is distributed into the direction of a paper discharge roller 41 and the direction of a recarrying unit 32. The sheet paper introduced into the paper discharge roller 41 is discharged into the paper discharge section 3. Also, the sheet paper introduced into the recarrying unit 32 is again introduced onto the direction of the secondary transfer roller 27.

The image forming station 11Y has the photoreceptor drum 12Y and a process measure in an integral manner and is provided in a detachable manner relative to a main body of the image forming apparatus. The process measure as referred to herein means at least one of the electrification charger 13Y, the development apparatus 14Y and the photoreceptor cleaning apparatus 15Y. Each of the image forming stations 11M, 11C and 11K has the same configuration as the image forming station 11Y. Each of the image forming stations 11Y, 11M, 11C and 11K may be detachable relative to the image forming apparatus or may be detachable as the integrated image forming unit 11 relative to the image forming apparatus.

Hereinafter, the present embodiments will be more specifically described with reference to Examples.

### [Production of Developer]

### Example 1

Amorphous polyester resin (binder): 80 parts by weight

Crystalline polyester resin: 9 parts by weight

Rice wax (release agent): 4 parts by weight

Coloring agent (MA-100): 6 parts by weight

Charge control agent (a polysaccharide compound containing Al and Mg): 1 part by weight

An amorphous polyester resin having a Tg of 57° C., a Tm of 114° C., and an acid value of 12 mgKOH/g and a crystalline polyester resin having a Tm of 101° C. were used and mixed with other materials in Henschel Mixer, and the resulting mixture was melt-kneaded by a twin-screw extruder. After the resulting melt-kneaded material was cooled, the cooled material was coarsely pulverized with a hammer mill, followed by finely pulverization with a jet pulverizing machine and classification, whereby a powder having a volume average particle diameter of 7 μm was obtained. The toner at this time had a Tg of 40.2° C., a Tm of 100.3° C., and an endothermic peak temperature as measured by a DSC of 96.5° C.

To 100 parts by weight of the thus obtained powder, the following fine particles of external additives were added and mixed by Henschel Mixer, whereby a toner was prepared.

### Fine Particles of External Additives:

Monodispersed fine particles of an inorganic compound having an average primary particle diameter of 105 nm, hydrophobic silica: 0.8 parts by weight

Hydrophobic silica having an average primary particle diameter of 30 nm: 1 part by weight

Hydrophobic titanium oxide having an average primary particle diameter of 20 nm: 0.5 parts by weight

The obtained toner was mixed with a silicone resin-surface coated ferrite carrier having an average particle diameter of 40 μm in an amount of 6 parts by weight with respect to 100 parts by weight of the ferrite carrier by stirring in a tabular mixer, thereby obtaining a developer.

### Examples 2 to 12 and Comparative Examples 1 to 7

Developers were obtained in the same manner as in Example 1 except that the blending components and the blending ratio were changed as shown in Table 1.

Incidentally, the glass transition points (Tg) of the resin and the toner were measured using a differential scanning calorimeter (DSC) “DSC Q2000” (manufactured by TA Instruments, Inc.). The measurement was performed under the following conditions: sample: 5 mg, lid and pan: alumina, temperature raising rate: 10° C./min, and measurement temperature: 20 to 200° C. A data was obtained by the measurement when the sample was heated to 200° C., followed by cooling the sample to 20° C. or lower and again heating the sample. Tangents on the low temperature side and the high temperature side of a curve generated at from around 30° C. to 60° C. were drawn, and a point of intersection of extension lines thereof was defined as a measured value.

In the measurement of the melting points (Tm) of the resin and the toner, a Koka-type flow tester (CFT-500D; manufactured by Shimadzu Corporation) was used. After setting a die, 1 g of a sample was placed on the die. By using a die having a pore size of 1 mm, the measurement was performed under the conditions of a temperature raising rate of 6° C./min and a measurement temperature of from 70 to 150° C. The temperature at a point on a flow curve corresponding to ½ of the dropping amount of a plunger was defined as a measured value based on the flowchart.

Further, the acid values of the resin and the toner were measured according to JIS K 0070.

In the measurement of the endothermic peak temperature of the toner, a differential scanning calorimeter (DSC) “DSC Q2000” (manufactured by TA Instruments, Inc.) was used. The measurement was performed under the following conditions: sample: 5 mg, lid and pan: alumina, temperature raising rate: 10° C./min, and measurement temperature: 20 to 200° C. A data was obtained by the measurement when the sample was heated to 200° C., followed by cooling the sample to 20° C. or lower and again heating the sample. The maximum endothermic peak temperature observed at from around 80 to 120° C. was defined as a measured value.

### [Evaluation Tests]

### Test for Low-Temperature Fixability

The fixing temperature was set to 130° C. by modifying a fixing system of a multifunction peripheral e-STUDIO 6530C (manufactured by Toshiba Tec Corporation) and a solid image was printed on 10 sheets of paper. A case where the image was not even slightly peeled off due to offset or non-fixation among the 10 sheets on which a solid image was printed was evaluated as “Good”, and a case where the image was peeled off was evaluated as “Bad”.

### Test for Fixable Range

The fixing temperature was set to 170° C. by modifying a fixing system of a multifunction peripheral e-STUDIO 6530C (manufactured by Toshiba Tec Corporation) and a solid image was printed on 10 sheets of paper. A case where the image was not even slightly peeled off due to offset or non-fixation among the 10 sheets on which a solid image was printed was evaluated as “Good”, and a case where the image was peeled off was evaluated as “Bad”.

### Test for Storage Stability

15 g of each toner was placed in a plastic container, and the container was hermetically sealed and left for 10 hours in a thermostat bath set at a temperature of 55° C. Then, the container was taken out from the thermostat bath and the toner was naturally cooled for 12 hours or more. Thereafter, the cooled toner was placed on a 42-mesh sieve and vibrated at a scale of 4 for 10 seconds using a powder tester (manufactured by Hosokawa Micron Corporation). A case where the residual amount of the toner on the sieve was 0 to 3 g or less was evaluated as “Good” and a case where the residual amount of the toner on the sieve was more than 3 g was evaluated as “Bad”.

### Prolongation of Life (Toner Scattering/Damage to Photoconductor)

An original document at a coverage of 8.0% was continuously copied on 80000 sheets of A4 paper using a multifunction peripheral e-STUDIO 6530C (manufactured by Toshiba Tec Corporation) in a test environment adjusted to a temperature of from 20 to 25° C. and a humidity of from 40 to 60%. A case where a smear due to the dropping of the toner on the image caused by toner scattering was not observed was evaluated as “Good”, and a case where such a smear was observed was evaluated as “Bad”.

The toners and the developers obtained in Examples 1 to 12 and Comparative Examples 1 to 7 were tested for low-temperature fixability, fixable range, storage stability, and prolongation of life by the above-described test methods. The results are shown in Table 1.

TABLE 1

| | Amorphous | | | Crystalline | | Toner | | | | External | | | | |
|---|---|---|---|---|---|---|---|---|---|---|---|---|---|---|
| | polyester resin | | | polyester | Charge | | | | DSC | additive | Low- | | | |
| | | | Acid | resin | control | | | Acid | peak | [nm] | temper- | | | |
| | | | value | Addition | agent | | | value | temper- | Particle | ature | Fix - | Storage | Prolong- |
| | Tg | Tm | (mgKOH/ | amount | Contained | Tg | Tm | mgKOH/ | ature | diameter | fix- | able | stabil- | ation |
| | (° C.) | (° C.) | g) | (wt %) | metals(s) | (° C.) | (° C.) | (g) | (° C.) | (nm) | ability | range | ity | of life |
| Example 1 | 57 | 114 | 12 | 9 | Al + Mg | 40.2 | 100.3 | 14.3 | 96.5 | 105 | Good | Good | Good | Good |
| Example 2 | 55 | 110 | 8 | 15 | Al + Mg | 34.5 | 95.8 | 9.5 | 90.4 | 105 | Good | Good | Good | Good |
| Example 3 | 60 | 120 | 17 | 3 | Al + Mg | 43.7 | 104.4 | 18.7 | 99.5 | 105 | Good | Good | Good | Good |
| Example 4 | 55 | 110 | 8 | 15 | Al + Mg | 38.3 | 98.5 | 9.7 | 99.5 | 105 | Good | Good | Good | Good |
| Example 5 | 60 | 120 | 17 | 3 | Al + Mg | 42.5 | 102.3 | 18.5 | 90.4 | 105 | Good | Good | Good | Good |
| Example 6 | 58 | 113 | 17 | 9 | Al + Mg | 40.9 | 100.1 | 18.3 | 96.5 | 105 | Good | Good | Good | Good |
| Example 7 | 56 | 112 | 8 | 9 | Al + Mg | 39.6 | 99.8 | 9.2 | 96.5 | 105 | Good | Good | Good | Good |
| Example 8 | 57 | 114 | 12 | 9 | Al + Mg + Fe | 40.5 | 100.5 | 14.5 | 96.5 | 105 | Good | Good | Good | Good |
| Example 9 | 57 | 114 | 12 | 9 | Al + Mg + Cr | 40.1 | 101.1 | 14.8 | 96.5 | 105 | Good | Good | Good | Good |
| Example 10 | 57 | 114 | 12 | 9 | Al + Mg + Zr | 40.8 | 99.9 | 13.9 | 96.5 | 105 | Good | Good | Good | Good |
| Example 11 | 55 | 110 | 8 | 15 | Al + Mg | 34.5 | 95.8 | 9.5 | 90.4 | 71 | Good | Good | Good | Good |
| Example 12 | 55 | 110 | 8 | 15 | Al + Mg | 34.5 | 95.8 | 9.5 | 90.4 | 150 | Good | Good | Good | Good |
| Comparative | 54 | 108 | 12 | 15 | Al + Mg | 33.2 | 94.1 | 15.2 | 89.5 | 105 | Good | Bad | Bad | Good |
| Example 1 | | | | | | | | | | | | | | |
| Comparative | 62 | 121 | 18 | 3 | Al + Mg | 45.1 | 106.1 | 18.9 | 101.3 | 105 | Bad | Good | Good | Good |
| Example 2 | | | | | | | | | | | | | | |
| Comparative | 56 | 113 | 18 | 9 | Al + Mg | 41.3 | 99.8 | 20.4 | 96.5 | 105 | Good | Good | Good | Bad |
| Example 3 | | | | | | | | | | | | | | |
| Comparative | 57 | 115 | 6 | 9 | Al + Mg | 39.4 | 100.2 | 8.2 | 96.5 | 105 | Good | Good | Good | Bad |
| Example 4 | | | | | | | | | | | | | | |
| Comparative | 57 | 114 | 12 | 9 | Fe | 40.5 | 101 | 13.8 | 96.5 | 105 | Good | Good | Good | Bad |
| Example 5 | | | | | | | | | | | | | | |
| Comparative | 57 | 114 | 12 | 9 | Cr | 40.8 | 99.8 | 14.6 | 96.5 | 105 | Good | Good | Good | Bad |
| Example 6 | | | | | | | | | | | | | | |
| Comparative | 57 | 114 | 12 | 9 | Zr | 39.9 | 100.4 | 14.9 | 96.5 | 105 | Good | Good | Good | Bad |
| Example 7 | | | | | | | | | | | | | | |

As shown in Table 1, the toners according to the present embodiment in Examples 1 to 12 showed favorable results with respect to all of the evaluation tests for low-temperature fixability, storage stability, fixable range, and prolongation of life.

On the other hand, in Comparative Example 1, in which the endothermic peak temperature as measured by DSC of the toner, the Tg of the toner, and the Tm of the toner were all lower than those of the toner according to the present embodiment, the fixable range at high temperatures was deteriorated and also the storage stability was poor. Further, in Comparative Example 2, in which the endothermic peak temperature as measured by DSC of the toner, the Tg of the toner, and the Tm of the toner were all higher than those of the toner according to the present embodiment, the low-temperature fixability was deteriorated. Further, in Comparative Example 3, in which the acid value of the amorphous polyester resin was high, the hygroscopicity is increased and an environmental change in charging amount was increased, and the prolongation of life was deteriorated. On the other hand, in Comparative Example 4, in which the acid value of the amorphous polyester resin was low, the absolute value of the charging amount was decreased and the toner scattering became worse. In Comparative Examples 5, 6, and 7, in which the metal contained in the charge control agent was changed to a simple substance of Fe, Cr, or Zr, respectively, the absolute value of the charging amount was decreased, and the toner scattering became worse, and also the prolongation of life was deteriorated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions the accompanying claims and their equivalents are intended to cover such forms or modifications as would fall within the scope and spirit of the inventions.

What is claimed is:

1. A developer comprising toner particles containing an amorphous polyester resin, a crystalline polyester resin, a coloring material, and a charge control agent containing metal elements of aluminum and magnesium, and having an endothermic peak temperature as measured by a differential scanning calorimeter (DSC) of from 90 to 100° C. and an acid value of from 9 to 19 mgKOH/g.

2. The developer according to claim 1, wherein the crystalline polyester resin is contained in the toner particles in an amount of from 3 to 15% by weight.

3. The developer according to claim 1, wherein the amorphous polyester resin has a glass transition point (Tg) of from 55 to 60° C. and a melting point (Tm) of from 110 to 120° C.

4. The developer according to claim 1, wherein the amorphous polyester resin has an acid value of from 7 to 17 mgKOH/g.

5. The developer according to claim 1, wherein the charge control agent contains a clathrate compound of a polysaccharide containing metal elements of aluminum and magnesium.

6. The developer according to claim 5, wherein the charge control agent further contains at least one metal element selected from iron, chromium, and zirconium.

7. The developer according to claim 1, wherein fine particles of an external additive are added to the surfaces of the toner particles.

8. The developer according to claim 7, wherein the fine particles of an external additive contain an inorganic oxide.

9. The developer according to claim 7, wherein the fine particles of an external additive contain an inorganic oxide having an average primary particle diameter of from 70 to 150 nm.

10. The developer according to claim 1, further comprising a release agent.

11. An image forming apparatus, comprising an image carrier for forming an electrostatic latent image thereon, a toner for use in developing an electrostatic latent image on the image carrier, and a developing device for accommodating a developer containing the toner therein,
the toner containing an amorphous polyester resin, a crystalline polyester resin, a coloring material, and a charge control agent containing metal elements of aluminum and magnesium, and having an endothermic peak temperature as measured by a differential scanning calorimeter (DSC) of from 90 to 100° C. and an acid value of from 9 to 19 mgKOH/g.

12. The apparatus according to claim 11, wherein the crystalline polyester resin is contained in the toner particles in an amount of from 3 to 15% by weight.

13. The apparatus according to claim 11, wherein the amorphous polyester resin has an acid value of from 7 to 17 mgKOH/g.

14. The apparatus according to claim 11, wherein the amorphous polyester resin has a glass transition point (Tg) of from 55 to 60° C. and a melting point (Tm) of from 110 to 120° C.

15. The apparatus according to claim 11, wherein the charge control agent contains a clathrate compound of a polysaccharide containing metal elements of aluminum and magnesium.

16. The apparatus according to claim 15, wherein the charge control agent further contains at least one metal element selected from iron, chromium, and zirconium.

17. The apparatus according to claim 11, wherein fine particles of an external additive are added to the surfaces of the toner particles.

18. The apparatus according to claim 17, wherein the fine particles of an external additive contain an inorganic oxide.

19. The apparatus according to claim 17, wherein the fine particles of an external additive contain an inorganic oxide having an average primary particle diameter of from 70 to 150 nm.

20. The apparatus according to claim 11, wherein the toner further contains a release agent.
